(19) United States
(12) Patent Application Publication
(10) Pub. No.: US 2008/0259060 A1
(43) Pub. Date: Oct. 23, 2008

(54) Video connection line to integrate analog and digital signals

(75) Inventor: Tzu-Chun Lin, Taipei (TW)

Correspondence Address: Joe McKinney Muncy, PO Box 1364, Fairfax, VA, 22038-1364, US

(73) Assignee: Shuttle Inc.

(21) Appl. No.: 11/785,522

(22) Filed: Apr. 18, 2007

(51) Int. Cl. G06F 3/038

(52) U.S. Cl. 345/204

(57) ABSTRACT

A video connection line to integrate digital and analog signals includes a first video connection port (may be one conforming to DVI-I specification) to transmit digital and analog signals that is divided to be coupled with a second video connection port (may be one conforming to DVI-D specification) to transmit digital video signals and a third video connection port (may be one conforming to VGA. D-SUB specifications) to transmit analog video signals. Thereby the DVI-I connection port supporting the digital and analog signals can be connected to a computer to output digital and analog signals at the same time to be used by the second and third connection ports, and displayed on different display devices.

### FIELD OF THE INVENTION

The present invention relates to a video connection line and particularly to a video connection line to integrate analog and digital signals.

### BACKGROUND OF THE INVENTION

On display devices and the peripheral devices thereof VGA connector (namely D-Sub, DB-15) is most widely used in the earlier period. As hardware technology advances, demands for dedicated digital is higher. A new DVI specification is introduced on the market. Simply speaking, D-Sub aims at transmitting analog signals. In the era in which CRT (cathode ray tube) was the main stream, digital signals in the VGA card have to be converted to analog signals before being displayed on the screen. In the conversion process the signals attenuate and are distorted. DVI specification can solve this problem. It is a totally digital transmission method. The signals are sent out from the VGA card in a digital format. The display end directly receives the digital format without the conversion process. As a result display quality improves.

DVI data format is based on the technology of PanelLink developed by Silicon Image Co. of USA (initially adopted on notebook computers). It employs the technology of Transition Minimized Differential Signaling (TMDS) to maintain the stability of high speed data stream transmission. In the newer version of DVI specification an extra set of DVI link channel is provided. When two sets of the links are used at the same time, an extra transmission bandwidth can be provided, called Dual-link DVI operation mode. In the DVI specification 165 MHz is the boundary of bandwidth. When the requirement of the display mode is lower than such a bandwidth, a single link operation is used. For the bandwidth higher than 165 MHz automatic switching to the dual-link is done. The second link may also transmit data of color pixels exceeding 24 bits. In addition, a DVI connector also has pins conforming to DDC-2 protocol same as the VGA interface to enable the VGA card to read EDID data on the screen and help the VGA card to determine possible output resolution.

There are two types of common DVI connectors on the market at present, namely DVI-Digital (DVI-D) and DVI-Integrated (DVI-I). DVI-D supports only digital display devices. DVI-I supports both digital and analog display. While DVI was a standard developed for liquid crystal display to perform digital transmission without lowering picture quality, conversion of analog signals still has to be taken into account. The DVI-D and DVI-I connectors are developed to meet those requirements. DVI-I can support DVI-D devices (including connection lines). But DVI-D connector cannot be coupled with DVI-I connection line. This is because DVI-I signal line has four more pins to transmit the analog signals. But the DVI-D connector does not have the pin holes. Thus they cannot be matched and coupled. As a result, on the market there are DVI-D connectors for liquid crystal screens while the connection line adopts DVI-I connector and the VGA card also adopts DVI-I connector.

The connectors of new and old specifications now on the market often make users confused. To make the VGA card compatible with the old CRT screen, D-Sub is still available on the market. The back panel of the computer has to provide different video output ports to meet the requirement of compatibility. As shrinking the size of computers is a prevailing trend, to provide different types of video output ports creates configuration problem in the limited space of the personal computer. Moreover, although the VGA cards now on the market provide the DVI-I connector to transmit digital and analog signals, only one type of signal can be transmitted at a given time. Two transmit two types of signals at the same time through one DVI-I connector is not allowed. And to display two types of signals through one DVI-I connector at the same time (dual view, the vista operation system of Microsoft Co. allows one computer to display pictures on different display devices) also is not possible. There are still rooms for improvement.

### SUMMARY OF THE INVENTION

The primary object of the present invention is to provide a video connection line to integrate analog and digital signals. It includes a first video connection port to support digital and analog video signals. After being connected to a computer or VGA card, the digital and analog signals can be output at the same time to be used by a second video connection port and a third video connection port, and be displayed respectively on different display devices.

To achieve the forgoing object, an embodiment of the invention includes a first video connection port to transmit digital and analog video signals (may be DVI-I specification), that is divided through a connection line to form a second video connection port (may be a DVI-D specification) to transmit the digital video signals and a third video connection port (may be VGA, D-Sub specifications) to transmit the analog signals.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of an embodiment of the invention.

FIG. 2 is a schematic view of pin layouts of various video connection ports according to the invention.

### DETAILED DESCRIPTION OF THE PREFERRED EMBODIMENT

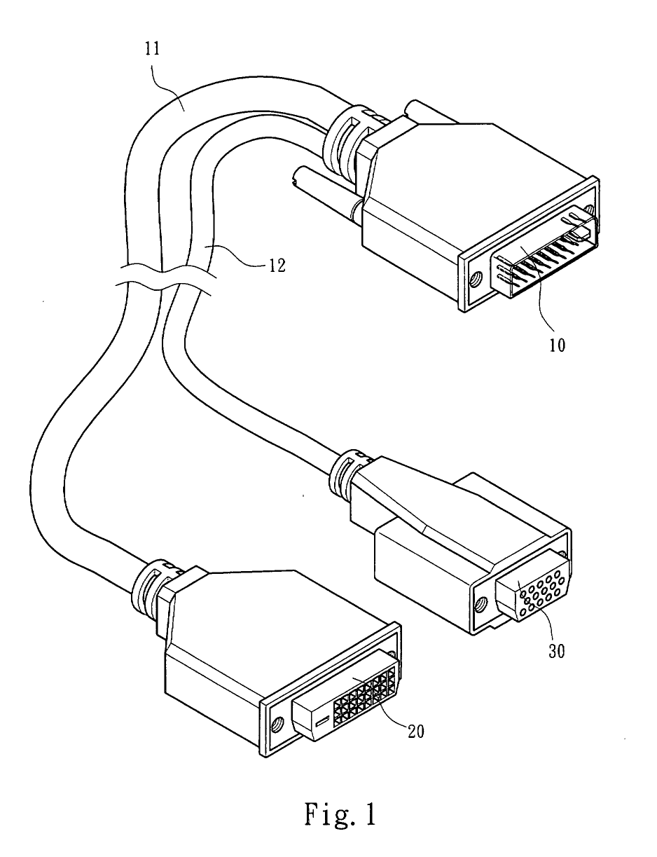

Please refer to FIG. 1 for the structure of an embodiment of the invention. The video connection line to integrate analog and digital signals of the invention includes a first video connection port 10 to transmit digital and analog signals, and a first connection line 11 and a second connection line 12 coupling with the first video connection port 10 (may be one conforming to DVI-I specification) at one end and coupling with a second video connection port 20 (may be one conforming to DVI-D specification) to transmit digital signals and a third video connection port 30 (may be one conforming to VGA, or D-SUB specifications) at other end. Thereby after the first video connection port 10 is connected to a computer or VGA card the digital and analog signals can be output at the same time to be used by the second and third connection ports 20 and 30, and also be displayed on different display devices.

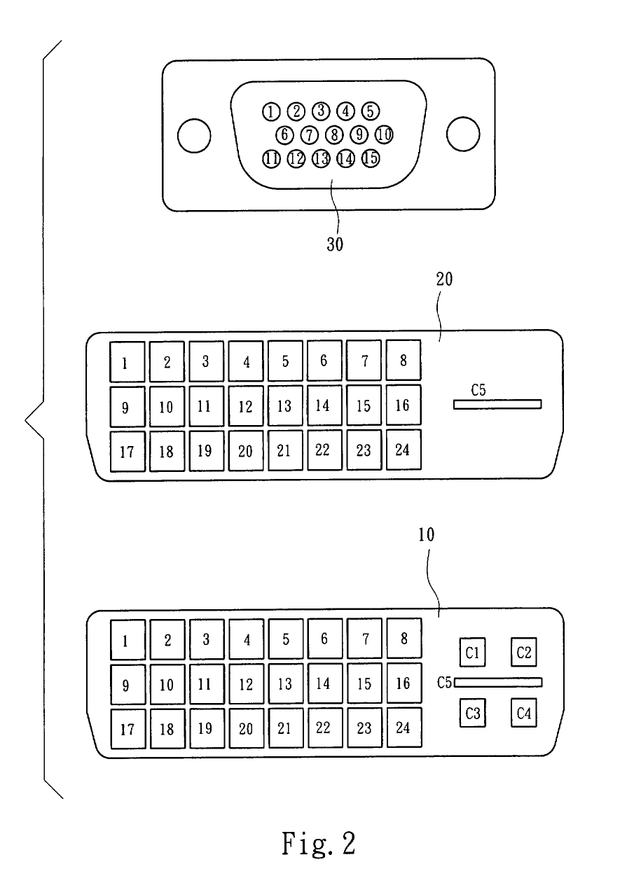

Referring to FIG. 2 and table 1 for comparison of DVI-I of the first video connection port 10 and pin layout:

TABLE 1
First video connection port 10 (DVI-I)

| | | |
|---|---|---|
| Pin 1 | TMDS DATA 2− | Digital red − (link 1) |
| Pin 2 | TMDS DATA 2+ | Digital red + (link 2) |
| Pin 3 | TMDS DATA 2/4 SHIELD | |
| Pin 4 | TMDS DATA 4− | Digital green − (link 2) |
| Pin 5 | TMDS DATA 4+ | Digital green + (link 2) |
| Pin 6 | DDC CLOCK | |
| Pin 7 | DDC DATA | |
| Pin 8 | Analog vertical sync | |
| Pin 9 | TMDS DATA 1− | Digital green − (link 1) |
| Pin 10 | TMDS DATA 1+ | Digital green + (link 1) |
| Pin 11 | TMDS DATA 1/3 SHIELD | |
| Pin 12 | TMDS DATA 3− | Digital blue − (link 2) |
| Pin 13 | TMDS DATA 3+ | Digital blue + (link 2) |
| Pin 14 | +5 V | Power for monitor when in standby |
| Pin 15 | Grand | Return for pin 14 and analog sync |
| Pin 16 | Hot plug detect | |
| Pin 17 | TMDS DATA 0− | Digital blue − (link 1) and |
| | | digital sync |
| Pin 18 | TMDS DATA 0+ | Digital blue + (link 1) and |
| | | digital sync |
| PIN 19 | TMDS DATA 0/5 SHIELD | |
| PIN 20 | TMDS DATA 5− | Digital red − (link 2) |
| PIN 21 | TMDS DATA 5+ | Digital red + (link 2) |
| PIN 22 | TMDS CLOCK SHIELD | |
| PIN 23 | TMDS CLOCK+ | Digital clock + (links 1 and 2) |
| PIN 24 | TMDS CLOCK− | Digital clock − (links 1 and 2) |
| C1 | Analog red | |
| C2 | Analog green | |
| C3 | Analog blue | |
| C4 | Analog horizontal sync | |
| C5 | Analog ground | Return for R, G, B signals |

DVI is the abbreviation of Digital Visual Interface. It is a video interface standard aims to improve picture quality of display devices of personal computers through digital transmission. It is now widely used on display devices such as LCD digital projectors. The second video connection port 20 conforms to DVI-D specifications and has a pin layout different from DVI-I. The second video connection port 20 (DVI-D) does not have pin positions of C1, C2, C3 and C4 for analog signals that are existed on the first video connection port 10 (DVI-I). It can be easily understood, hence no table is presented.

Refer to FIG. 2 and Table 2 for comparison of VGA (D-SUB) pin layout of the third video connection port 30:

TABLE 2
Third video connection port 30 (VGA, D-SUB)

| | | |
|---|---|---|
| Pin 1 | RED | RED VIDEO |
| Pin 2 | GREEN | GREEN VIDEO |
| Pin 3 | BLUE | BLUE VIDEO |
| Pin 4 | N/C | CONNECTED |
| Pin 5 | GND | GROND |
| Pin 6 | RED_RTN | RED RETURN |
| Pin 7 | GREEN_RTN | GREEN RETURN |
| Pin 8 | BLUE_RTN | BLUE RETURN |
| Pin 9 | N/C | CONNECTED |
| Pin 10 | GND | GROUND |
| Pin 11 | N/C | CONNECTED |
| Pin 12 | SDA | I²C DATA |
| Pin 13 | HSYNC | SYNC |
| Pin 14 | VSYNC | SYNC |
| Pin 15 | SCL | I²C CLOCK |

The first connection line 11 and the second connection line 12 are split to connect respectively to the second video connection port 20 (may be DVI-D specification) to transmit digital video signals and the third video connection port 30 (may be VGA, D-SUB specifications) to transmit analog signals.

TABLE 3

| First video | | Third video | | Second video | |
|---|---|---|---|---|---|
| connection port | | connection port | | connection port 20 | |
| 10 (DVI-I) | | 30 (VGA, D-SUB) | | (DVI-D) | |
| Pin 1 | TMDS | | | Pin 1 | TMDS |
| | DATA 2− | | | | DATA 2− |
| Pin 2 | TMDS | | | Pin 2 | TMDS |
| | DATA 2+ | | | | DATA 2+ |
| Pin 3 | TMDS | | | Pin 3 | TMDS |
| | DATA 2/4 | | | | DATA 2/4 |
| | SHIELD | | | | SHIELD |
| Pin 4 | TMDS | | | Pin 4 | |
| | DATA 4− | | | | |
| Pin 5 | TMDS | | | Pin 5 | |
| | DATA 4+ | | | | |
| Pin 6 | DDC | | | Pin 6 | DDC |
| | CLOCK | | | | CLOCK |
| Pin 7 | DDC DATA | | | Pin 7 | DDC |
| | | | | | DATA |
| Pin 8 | Analog | Pin 8 | VSYNC | Pin 8 | Analog |
| | vertical | | | | vertical |
| | sync | | | | sync |
| Pin 9 | TMDS | | | Pin 9 | TMDS |
| | DATA 1− | | | | DATA 1− |
| Pin 10 | TMDS | | | Pin 10 | TMDS |
| | DATA 1+ | | | | DATA 1+ |
| Pin 11 | TMDS | | | Pin 11 | TMDS |
| | DATA 1/3 | | | | DATA 1/3 |
| | SHIELD | | | | SHIELD |
| Pin 12 | TMDS | | | Pin 12 | |
| | DATA 3− | | | | |
| Pin 13 | TMDS | | | Pin 13 | |
| | DATA 3+ | | | | |
| Pin 14 | +5 V | Pin 9 | VCC | Pin 14 | +5 V |
| Pin 15 | Grand | | | Pin 15 | Grand |
| Pin 16 | Hot plug | | | Pin 16 | Hot plug |
| | detect | | | | detect |
| Pin 17 | TMDS | | | Pin 17 | TMDS |
| | DATA 0− | | | | DATA 0− |
| Pin 18 | TMDS | | | Pin 18 | TMDS |
| | DATA 0+ | | | | DATA 0+ |
| PIN 19 | TMDS | | | PIN 19 | TMDS |
| | DATA 0/5 | | | | DATA 0/5 |
| | SHIELD | | | | SHIELD |
| PIN 20 | TMDS | | | PIN 20 | |
| | DATA 5− | | | | |
| PIN 21 | TMDS | | | PIN 21 | |
| | DATA 5+ | | | | |
| PIN 22 | TMDS | | | PIN 22 | TMDS |
| | CLOCK | | | | CLOCK |
| | SHIELD | | | | SHIELD |
| PIN 23 | TMDS | | | PIN 23 | TMDS |
| | CLOCK+ | | | | CLOCK+ |
| PIN 24 | TMDS | | | PIN 24 | TMDS |
| | CLOCK− | | | | CLOCK− |
| C1 | Analog red | Pin 1 | RED | C1 | |
| C2 | Analog | Pin 2 | GREEN | C2 | |
| | green | | | | |
| C3 | Analog | Pin 3 | BLUE | C3 | |
| | blue | | | | |
| C4 | Analog | Pin 13 | HSYNC | C4 | |
| | horizontal | | | | |
| | sync | | | | |
| C5 | Analog | Pin 5□ | GROUND | C5 | Analog |
| | ground | 6□7□8□ | | | ground |
| | | 10 | | | |

Table 3 indicates that the first video connection port 10 has a first digital pin to transmit the digital signals, a first analog pin to transmit the analog video signals, a first power pin to transmit power signals and a first ground pin to be grounded.

The second video connection port 20 to transmit the digital video signals includes at least a second digital pin, a second power pin and a second ground pin corresponding respectively to the pin positions of the first digital pin, first power pin and first ground pin. The first connection line 11 connects the corresponding first and second digital pins, first and second power pins and first and second ground pins.

The third video connection port 30 to transmit the analog signals includes at least a third analog pin, a third power pin and a third ground pin corresponding to the pin positions of the first analog pin, first power pin and first ground pin. The second connection line 12 connects the corresponding first and third analog pins, first and third power pins, and first and third ground pins.

The second video connection port 20 has a plurality of second ground pins (Pins 5, 6, 7, 8 and 10) that are jointly connected to the single first ground pin (Pin C5) of the first video connection port 10 through the first connection line 11.

The first, second and third video connection ports 10, 20 and 30 have respectively a vertical synchronous signal pin (V-sync). The second video connection port 20 has a vertical synchronous signal pin (Pin 8) and the third video connection port 30 has a vertical synchronous signal pin (Pin 14) jointly connected to a vertical synchronous signal pin (Pin 8) of the first video connection port 10 through the first and second connection lines 11 and 12.

In addition, the first, second and third video connection ports 10, 20 and 30 have respectively a power pin. The power pins (pin 14 and 9) of the second video connection port 20 and the third video connection port 30 are jointly connected to a single power pin (Pin 14) of the first video connection port 10 through the first and second connection lines 11 and 12.

The invention provides a video connection line to integrate analog and digital signals. It has the first video connection port 10 to support digital and analog signals and is connected to a computer or VGA card to output digital and analog signals at the same time to be used by the second and third video connection ports 20 and 30, and to display the signals on different display devices.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A video connection line to integrate analog and digital signals, comprising:
a first video connection port to transmit digital and analog video signals having a first digital pin to transmit the digital video signals, a first analog pin to transmit the analog video signals, a first power pin to transmit power signals and a first ground pin to be grounded;
a second video connection port to transmit digital video signals having a second digital pin, a second power pin and a second ground pin corresponding respectively to the first digital pin, the first power pin and the first ground pin, the first video connection port and the second video connection port being bridged by a first connection line which connects the corresponding first and second digital pins, the first and second power pins and the first and second ground pins; and
a third video connection port to transmit analog signals having at least a third analog pin corresponding to the first analog pin, a third power pin corresponding to the first power pin, and a third ground pin corresponding to the first ground pin, the first video connection port and the third video connection port being bridged by a second connection line which connects the corresponding first and third analog pins, the first and third power pins and the first and third ground pins.

2. The video connection line of claim 1, wherein the third video connection port has a plurality of ground pins which are jointly connected to a single first ground pin of the first video connection port through the second connection line.

3. The video connection line of claim 1, wherein the first, second and third video connection ports have respectively a vertical synchronous signal pin, the vertical synchronous signal pins of the second and third video connection ports being jointly connected to the vertical synchronous signal pin of the first video connection port through the first and second connection lines.

4. The video connection line of claim 1, wherein the first, second and third video connection ports have respectively a power pin, the power pins of the second and third video connection ports being jointly connected to a single power pin of the first video connection port through the first and second connection lines.

5. The video connection line of claim 1, wherein the first video connection port and the second video connection port conform to a digital image interface specification.

6. The video connection line of claim 4, wherein the first video connection port conforms to DVI-I specification to transmit the digital and analog video signals.

7. The video connection line of claim 4, wherein the second video connection port conforms to DVI-D specification to transmit the digital video signals.

8. The video connection line of claim 1, wherein the third video connection port is a VGA connection port to transmit the analog video signals.

9. The video connection line of claim 1, wherein the first video connection port is connected to a computer, and the second and third video connection ports are connected to at least one display device.
